(19) United States
(12) Patent Application Publication
(10) Pub. No.: US 2008/0071863 A1
(43) Pub. Date: Mar. 20, 2008

(54) Application sharing system, application sharing apparatus and application sharing program

(75) Inventor: Hideo Kinami, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/723,299

(22) Filed: Mar. 19, 2007

(30) Foreign Application Priority Data
Sep. 14, 2006 (JP) 2006-248845

(51) Int. Cl. G06F 15/16

(52) U.S. Cl. 709/204

(57) ABSTRACT

An application sharing system includes: a first apparatus; and a second apparatus, connected to each other through a communication channel, wherein the first apparatus comprises: an introducing unit that introduces an application used by a function owned by the first apparatus into the first apparatus; and a recording unit that records not only function information for specifying the function of the first apparatus using the application but also address information of the first apparatus on a portable recording medium, and the second apparatus comprises: a reading unit that reads out the function information and the address information from the portable recording medium; and an obtaining unit that obtains the application from the first apparatus according to the address information when the second apparatus has the function to be specified by the function information.

### CROSS-REFERENCE TO RELATED APPLICATION

This application is based on and claims priority under 35 USC 119 from Japanese Patent Application No. 2006-248845 filed Sep. 14, 2006.

### BACKGROUND

1. Technical Field

The present invention relates to an application sharing system, an application sharing apparatus and an application sharing program.

2. Related Art

Recently, there have been widely spread a copying machine, a printing machine, a scanning machine, a facsimile machine and a composite machine which is an integrated apparatus of these machines. Since such machine or apparatus is installed in a store such as a convenience store and in an office and is used by a large number of users, there arises a need that the using environment of such apparatus can be changed for every user.

### SUMMARY

According to an aspect of the invention, there is provided an application sharing system including: a first apparatus; and a second apparatus, connected to each other through a communication channel, wherein the first apparatus comprises: an introducing unit that introduces an application used by a function owned by the first apparatus into the first apparatus; and a recording unit that records not only function information for specifying the function of the first apparatus using the application but also address information of the first apparatus on a portable recording medium, and the second apparatus comprises: a reading unit that reads out the function information and the address information from the portable recording medium; and an obtaining unit that obtains the application from the first apparatus according to the address information when the second apparatus has the function to be specified by the function information.

### BRIEF DESCRIPTION OF THE DRAWINGS

Exemplary Embodiments of the present invention will be described in detail based on the following figures, wherein:

FIG. 1 illustrates a schematic view of the structure of an application sharing system;

FIG. 2 illustrates a schematic view of the structure of the appearance of a composite machine (apparatus);

FIG. 3 illustrates a block diagram of the system structure of a composite machine (apparatus);

FIG. 4 illustrates a schematic view of the storage contents of an HDD;

FIG. 5 illustrates a block diagram of the function structure of a composite machine (apparatus);

FIG. 6 illustrates a flow chart of the operation of a composite machine (apparatus);

FIG. 7 illustrates a flow chart of the operation of a composite machine (apparatus);

FIG. 8 illustrates a schematic view of an exemplary example of user data information;

FIG. 9 illustrates a schematic view of an exemplary example of a function list;

FIG. 10 illustrates a schematic view of an exemplary example of the display of an operation panel;

FIG. 11 illustrates a schematic view of an exemplary example of the display of an operation panel;

FIG. 12 illustrates a block diagram of an exemplary example of the system structure of an IC chip to be built in an IC card; and

FIG. 13 illustrates a schematic view of an exemplary example of composite machine data information.

### DETAILED DESCRIPTION

Now, description will be given below of an exemplary embodiment of the invention with reference to the accompanying drawings.

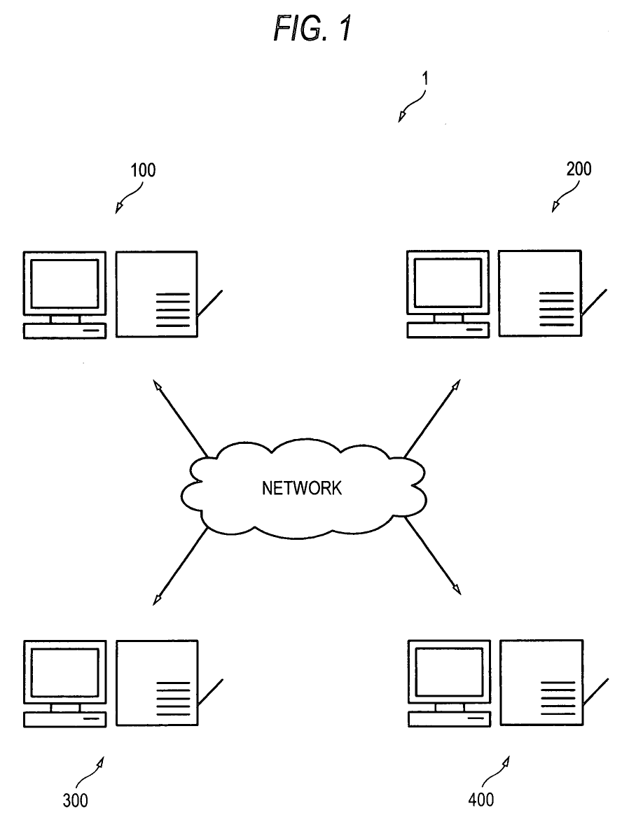

FIG. 1 is a schematic view of an exemplary example of the structure of an application sharing system. In this application sharing system, as an exemplary example of the apparatus, composite machines 100˜400 are respectively connected to a network composed of communication channels, whereby the composite machines 100˜400 are capable of communicating with each other.

These composite machines 100˜400 respectively have at least two functions of a copy function, a print function, a scan function and a facsimile function. By the way, in the present embodiment, as an exemplary example of the apparatus, there are taken the composite machines; however, the invention is not limited to this but there may also be a copying machine, a printer, a scanner, a facsimile machine, or the like.

These composite machines 100˜400 are installed, for example, in a store such as a convenience store and are used by a large number of users.

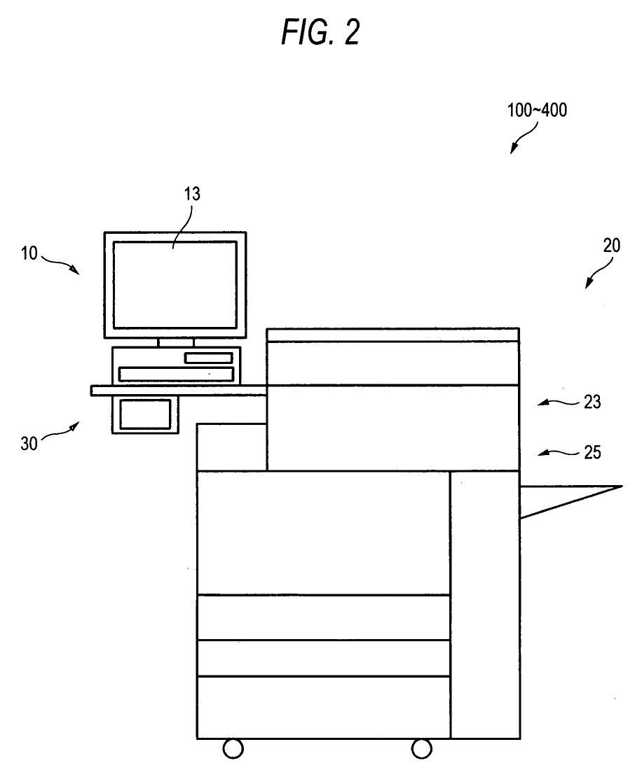

FIG. 2 is a schematic view of an exemplary example of the appearance of each of the composite machines 100˜400. This composite machines 100˜400 respectively comprise: a composite apparatus part 20 including a printer part 23, a scanner part 25 and the like; a computer (PC) 10 including an operation panel 13 for accepting a user's operation and the like; and, an IC card reader 30 capable of gaining access to information about electronic money recorded on a contactless IC chip built in an IC card, a cellular phone or the like owned by a user.

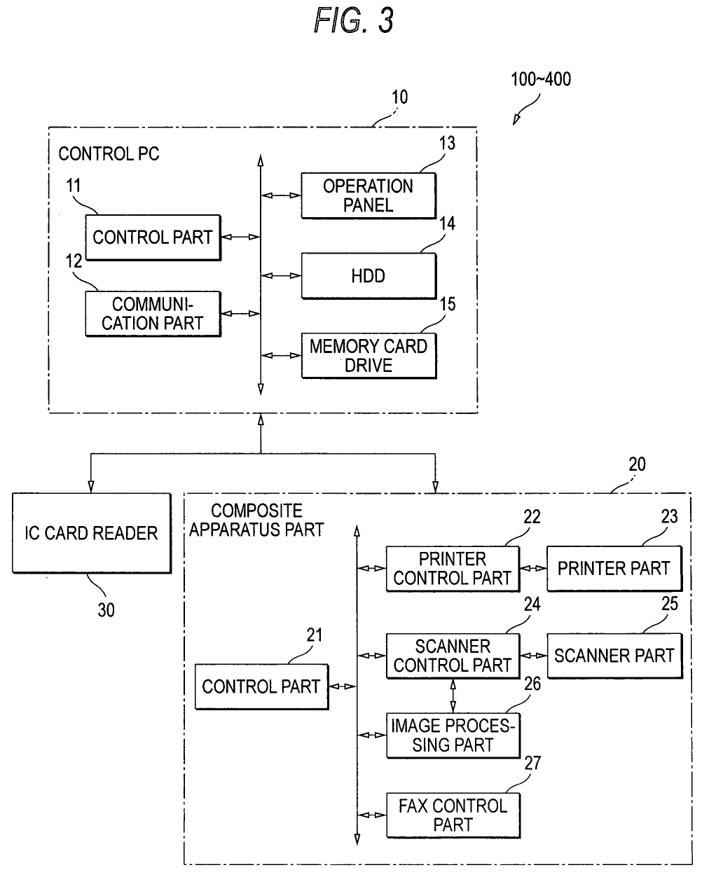

FIG. 3 is a block diagram of an exemplary example of the structure of each of the composite machines 100˜400. The composite machines 100˜400 each includes the PC 10, the composite apparatus part 20, and the IC card reader 30, in which the respective parts are capable of communicating with each other.

The PC 10 includes a control part 11 composed of a CPU and the like, a communication part 12 capable of communication with other apparatus such as the composite machines 200˜400, an operation panel 13 composed of a display part and an operation part unified as an integrated body, a hard disk drive (HDD) 14, and a memory card drive 15.

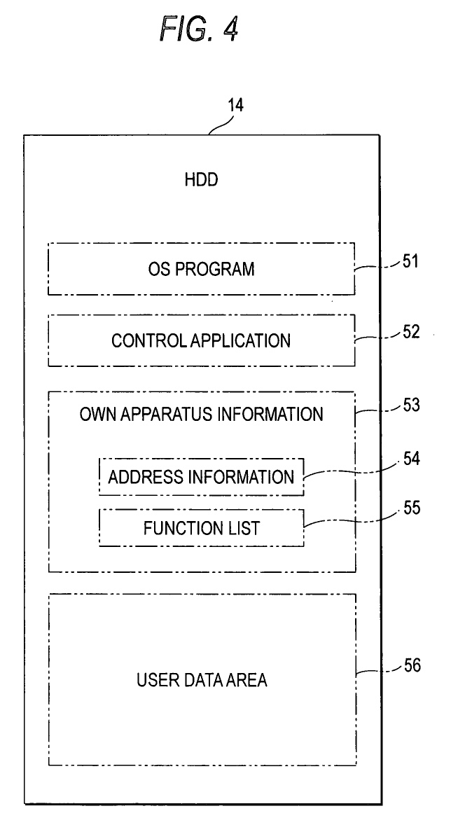

The HDD 14 stores therein programs and data necessary for the operation of the CPU of the control part 11. FIG. 4 shows an exemplary example of the storage contents of the HDD 14. The HDD 14 stores therein an OS (operating system) program 51 and a control application 52 to be operated on the OS program 51. This control application 52 is, for example, a program for giving the composite apparatus part 20 the operation parameters of a job (an operation to be executed based on the function). Such program can be stored in a medium such as a CD-ROM.

Also, the HDD 14 stores also its own apparatus information including the address information 54 and function list 55 of its own apparatus, and a user data area 56 containing an application introduced when the HDD 14 is shipped from its manufacturing factory or an application installed by a user. The term “introduction” means that an application is processed into a state where it can be used in a computer, for example, it includes a “setup” operation and an “installation” operation. Description will be given later of the details of these processings.

The memory card drive 15 executes data read and write operations on a memory card composed of, for example, a flash memory. In this memory card, there is recorded an application to be set up (introduced) into the PC 10; and thus, the memory card is regarded as one of application supply sources.

The composite apparatus part 20 includes a control part 21, a printer control part 22, a printer part 23, a scanner control part 24, a scanner part 25, an image processing part 26, and a fax control part 27.

The control part 21 controls the whole operation of the composite apparatus part 20 in linking with the printer control part 22, scanner control part 24, image processing part 26 and fax control part 27.

The printer control part 22 controls the operation of the printer part 23 and, specifically, realizes a copy function and a print function. Also, the scanner control part 24 controls the operation of the scanner part 25 and, specifically realizes a copy function, a facsimile function and a scan function. The image processing part 26 enforces an image processing on image data or the like which the scanner part has obtained by scanning. The fax control part 27 is connected to a public telephone circuit and realizes a facsimile function.

The IC card reader 30 is capable of gaining access to information such as electronic money recorded on a contactless IC chip built in an IC card or a cellular phone owned by a user.

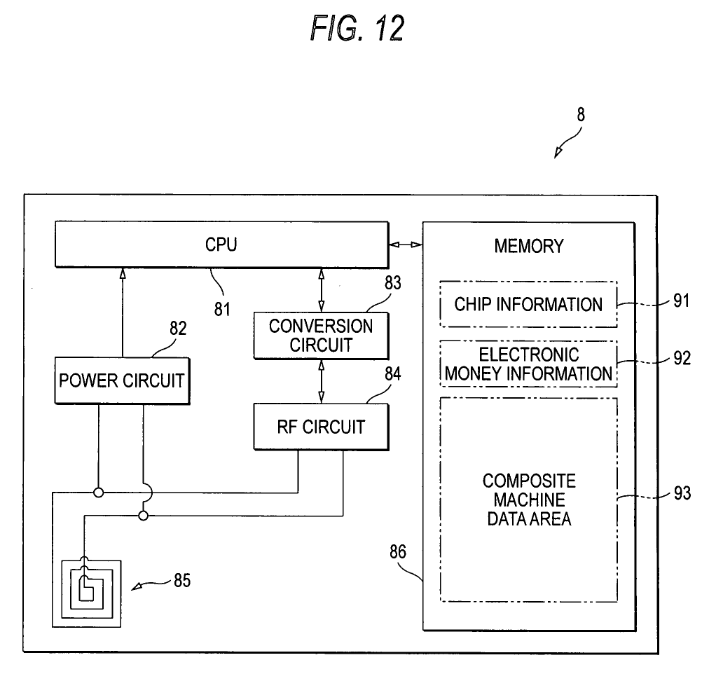

Here, description will be given of an IC chip to which the IC card reader 30 gains access. FIG. 12 is a block diagram of an IC chip 8. The IC chip 8 includes a CPU 81 for controlling the whole operation of the IC chip 8, a power circuit 82, a conversion circuit 83, an RF (radio frequency amplification) circuit 84, an antenna 85 for transmitting and receiving electromagnetic waves of a specific frequency, and a memory (recording medium) 86.

The power circuit 82 cooperates together with the antenna 85 in constituting a resonant circuit; and, when the antenna 85 receives electromagnetic waves of a specific frequency, the power circuit 82, due to its mutual inductance operation, stores power in a built-in capacitor, rectifies the stored power and supplies the rectified power to the CPU 81 and the like.

The conversion circuit 83 demodulates and decodes a signal inputted from the RF circuit 84 and outputs the thus obtained digital data to the CPU 81. Also, the conversion circuit 83 encodes and modulates the digital data inputted from the CPU 81 and outputs the thus obtained signal to the RF circuit 84.

The RF circuit 84, when the antenna 85 receives electromagnetic waves of a specific frequency, amplifies a signal inputted from the antenna 85 and outputs the thus amplified signal to the conversion circuit 83. Also, the RF circuit 84 amplifies a signal inputted from the conversion circuit 83 and supplies the thus amplified signal to the antenna 85.

The memory 86 is composed of a nonvolatile memory (for example, EEPROM), while information can be written into and read out from the memory 86 by the CPU 81. In the memory 86, there are stored chip information 91 which is used to identify this IC chip 8 (and thus a user who owns this IC chip 8), and electronic money information 92 showing the balance that can be settled. Also, in the memory 86, as will be discussed later, there are stored information about an application set up (introduced), address information and other similar information.

Here, since the IC chip 8 is built in a thing that the user can carry (a portable thing) such as an IC card and a cellular phone, the memory 86 contained in the IC chip 8 can be said that it is a portable recording medium. By the way, as a portable recording medium, the IC chip 8 is not limitative but, for example, there may also be used a memory card or a USB memory.

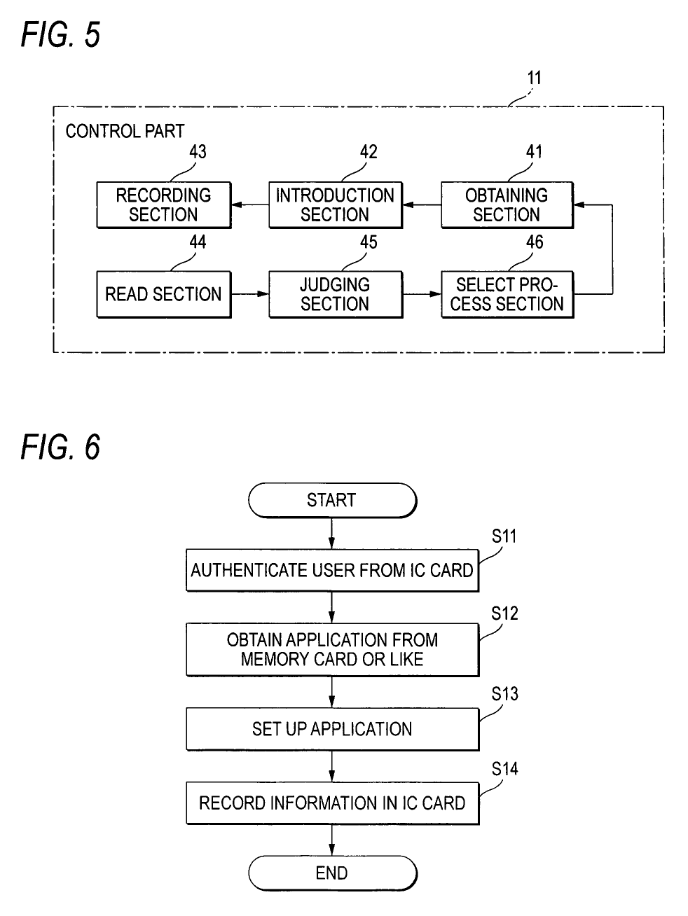

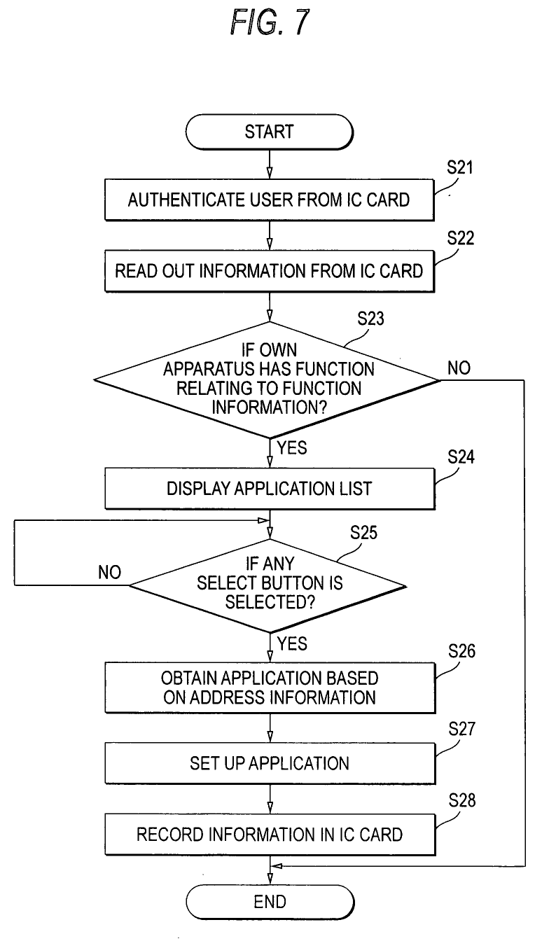

FIG. 5 is a block diagram of an exemplary example of the function structure of the control part 11 contained in the PC 10. The control part 11, functionally, includes an obtaining section 41, an introduction section 42, a recording section 43, a read section 44, a judging section 45, and a select process section 46. These composing elements can be realized by the software operation of the CPU contained in the control part 11. Also, FIGS. 6 and 7 are respectively flow charts of the operation of the control part 11.

### [Normal Set-Up Processing]

FIG. 6 is a flow chart of the operation of a normal setup processing to be executed by the control part 11. This is an operation to set up for the first time an application in one of the composite machines 100˜400 installed in a store such as a convenience store. Here, as an exemplary example, it is assumed that the application is set up in the composite machine 100 (a first apparatus).

In the composite apparatus 100, an IC card reader 30 reads out chip information 91 (see FIG. 12) from an IC chip 8 built in an IC card or a cellular phone owned by a user and, when it authenticates the user, it outputs an authentication signal, which shows that it has authenticated the user, to the PC 10. On receiving this authentication signal (S11), the control part 11 of the PC 10 starts the following operation.

Firstly, the obtaining section 41, according to an instruction given from a user who operates the operation panel 13, obtains an application recorded on a memory card owned by the user from a memory card drive 15 (S12). By the way, the obtaining of the application is not limited to this but, for example, the application may also be obtained from a server device (not shown) on a network through communication, or may be obtained from other drive devices (not shown) such as a CD-ROM drive incorporated in the PC 10.

Here, the application that is obtained by the obtaining section is, for example, an application which is used by a copy function, a print function, a scan function and a facsimile function respectively owned by the composite machine 100.

As an exemplary example of such application, there can be pointed out an application which operates on a control application 52 (for example, an applet). The application, which operates on the control application 52, is an application that enforces a given modification on operation parameters to be applied to the composite apparatus part 20 by the control application 52; and, specifically, it is an application that changes the operation parameters so as to add a given transparent image to image data to be formed on a sheet by the copy function or by the print function, or to image data to be taken in by the scan function or by the facsimile function.

Also, as an exemplary example of the above-mentioned application, there can be pointed out an application which contains information necessary to generate job parameters which the control application 52 gives to the composite apparatus part 20; for example, in the facsimile function, a telephone book application which contains the number information of the receivers.

Also, the above-mentioned application may also be an application which is used by two or more functions owned by the composite machine 100. For example, there is available an instruction information (job flow) application in which there are written the steps of processing two or more jobs to be executed by the composite apparatus part 20.

By the way, the function owned by the composite machine 100 can also be classified into detailed functions which belong to the copy function, print function, scan function and facsimile function. For example, for the copy function and print function, they can be classified into detailed functions such as a black-and-while print function, a color print and a both-side print function which respectively belong to the copy function and print function. Therefore, as the above-mentioned application, there may also be employed such application that can be used only for the detailed functions belonging to the functions owned by the composite machine 100. For example, there is available an application which can be used only for the both-side print function belonging to the copy function and print function.

Next, the introduction section 42 sets up the application obtained by the obtaining section 41 in its own apparatus (composite machine 100) (S13). That is, the introduction section 42 copies the application obtained by the obtaining section 41 into the user data area 56 (see FIG. 4) of the HDD 14 and, as the need arises, initializes the application.

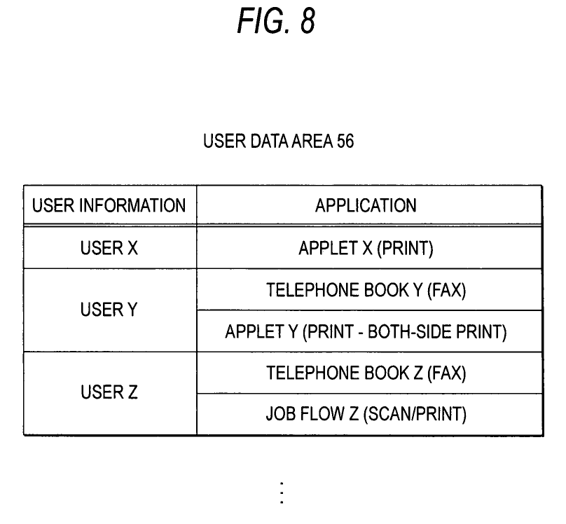

FIG. 8 shows an exemplary example of the contents of the user data area 56. In FIG. 8, there is shown an exemplary example in which applications set up by the respective users are stored in the user area 56. In the user data area 56, the set up applications are stored in relation to the respective pieces of information about the users including the authentication information about the users and other similar information.

Since the applications are set up in this manner, the user is able to use the present applications in the composite machine 100.

Next, the recording section 43 outputs the information about the applications set up by the introduction section 42 and other similar information to the IC card reader 30 to thereby allow the IC card reader 30 to record such pieces of information on the composite machine data area 93 (see FIG. 12) of a memory 86 included in the IC chip 8 owned by the user (S14).

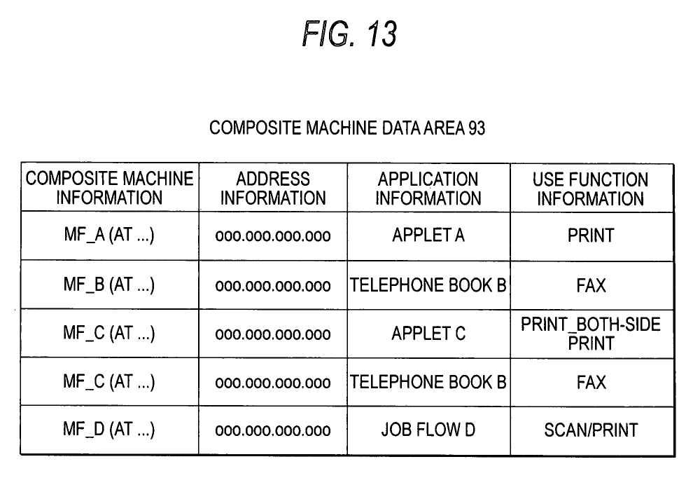

FIG. 13 shows an exemplary example of the contents of the composite machine data area 93. In this figure, there is shown an exemplary example in which some pieces of information about applications respectively set up in the respective composite machines are stored in the composite machine data area 93.

In this composite machine data area 93, as information for specifying a composite machine, there are recorded composite machine information describing information about the composite machine as well as address information describing the IP address and the like for specifying the position of the composite machine on the network. The composite machine information includes information about the name of the apparatus and about the installation place of the apparatus such as the name of a store and the name of a place. These pieces of composite machine information and address information are based on, for example, apparatus's own information 53 stored in the HDD 14 of the PC 10 (see FIG. 4).

Also, in the composite machine data area 93, as the information for specifying an application set up in the composite machine, there are recorded application information describing the application name of the application set up in the composite apparatus and, as an exemplary example of function information, use function information describing the kind of the function of the composite machine which uses this application. This application information is not limited to the name of the application but may only describe the information that can specify the application set up in the composite machine. Also, the application information is requested that the data quantity thereof is smaller than the application itself in order to control the use capacity of the memory 86.

This completes the normal set-up processing in the composite machine 100.

[Set-Up Processing to be Executed by Obtaining Application from Other Apparatus]

FIG. 7 is a flow chart to show an exemplary example of the operation of another set-up processing to be executed by the control part 11. This is an operation in which, for example, when an application has been already set up in one of the composite machines 100˜400 installed in a store such as a convenience store, the application is obtained from the present composite machine and is set up in the other composite machine. Here, as an exemplary example, it is assumed that the composite machine 200 (a second apparatus) obtains the application set up in the composite machine 100 (a first apparatus) and sets up the application in the composite machine 200 itself.

In the composite machine 200, when the IC card reader 30 reads out chip information 91 (see FIG. 12) from an IC chip 8 built in an IC card or a cellular phone owned by a user to thereby carries out the authentication of the user, the IC card reader 30 outputs to the PC 10 an authentication signal showing that the user has been authenticated. The control part 11 of the PC 10, when it receives this authentication signal (S21), starts the following operations.

That is, firstly, the read section 44 allows the IC card reader 30 to read information recorded on the composite machine data area 93 (see FIG. 12) of the memory 86 incorporated in the IC chip 8 owned by the user, thereby obtaining such information (S22). In the composite machine data area 93, as shown in the above-mentioned FIG. 13, there are recorded the composite machine information, address information, application information and use function information; and, the read section 44 obtains these pieces of information.

Next, the judging section 45, based on the use function information obtained by the read section 44, checks whether its own apparatus (composite machine 200) has a function of the kind specified by the use function information or not (S23). This check is carried out by referring to a function list 55 (see FIG. 4) stored in the HDD 14 of the PC 10.

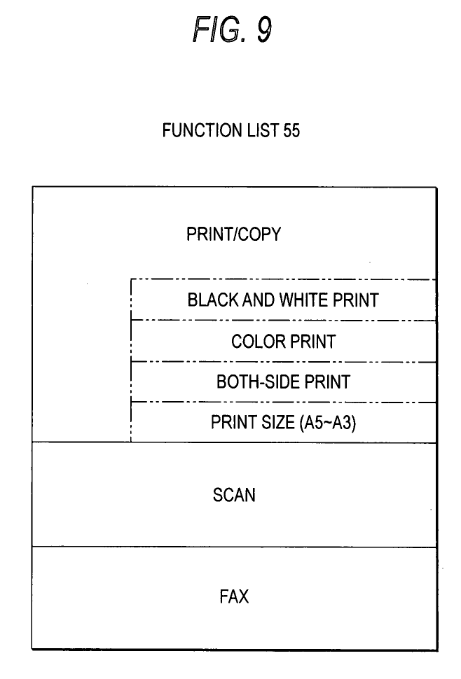

FIG. 9 shows an exemplary example of the contents of the function list 55. In the function list 55, there are described the functions that the composite apparatus 200 has, for example, a copy function, a print function, a scan function and a facsimile function. Also, in the function list 55, there are also set forth detailed functions that belong to the above functions, for example, for the copy function and print function, there are set forth the detailed functions that belong to the copy and print functions, such as a black and white print function, a color print function and a both-side print function.

And, when its own apparatus (composite machine 200) has the function of the kind specified by the use function information (S23: YES), the select process section 46, based on the application information obtained by the read section 44, displays on the application panel 13 a list of applications that can be set up in its own apparatus, thereby prompting the user to select one of the applications (S24). On the other hand, when its own apparatus (composite machine 200) has not the function of the kind specified by the use function information (S23: NO), since the applications that can be set up in its own apparatus are not present in the other composite machines 100, 300 and 400, the select process section 46 ends the set-up processing.

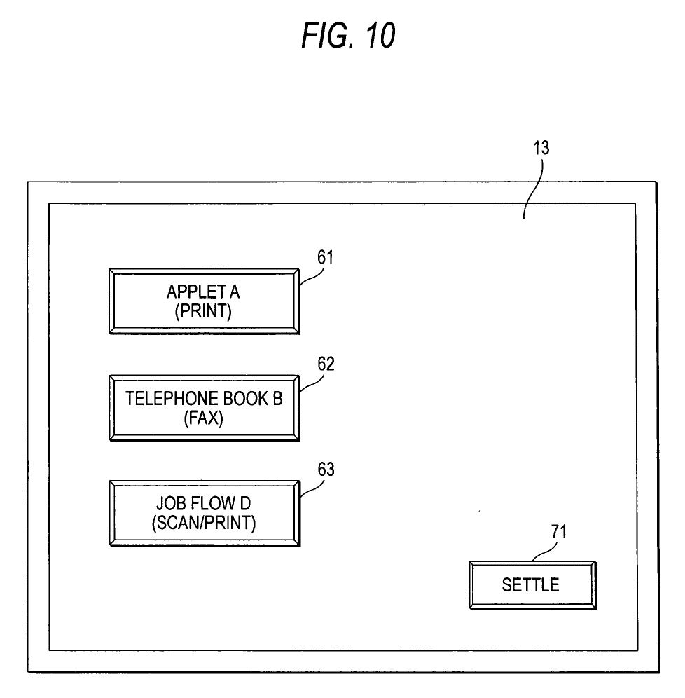

FIG. 10 shows an exemplary example of the display of the operation panel 13. On the display screen of the operation panel 13, based on the application information obtained by the read section 44, there are displayed select buttons 61˜63 which respectively describe the application names of an application that can be set up in its own apparatus. Also, on the display screen of the operation panel 13, there is also displayed a settle button 71 which will be discussed later.

And, when the select process section detects that one of the select buttons 61˜63 is selected by the user (S25: YES), the obtaining section 41 obtains an application related to the selected application name from the composite machine (here, composite machine 100) which has set up the present application, of the other remaining composite machines 100, 300 and 400, through the network based on the address information obtained by the read section (S26).

Here, in the composite machine 100, as described above, there is stored the application set up in the user data area 56 of the HDD 14 while it is related to the user information (see FIG. 8); and, the composite machine 100, in response to an obtaining request from the composite machine 200 including the user authentication information and information about the selected application name, reads out the corresponding application from applications stored related to the corresponding user information, and transmits the present application to the composite machine 200. As a result of this, the composite machine 200 obtains the application.

By the way, when two or more composite machines have set up the application related to the selected application name, the obtaining section 41 transmits a network diagnostic packet to the two or more corresponding composite machines, selects a composite machine having good transfer efficiency based on the packets returned, and obtains an application from the selected composite machine. This operation may be carried out, for example, by selecting the composite machine that has returned the packet most quickly as the composite apparatus having good transfer efficiency.

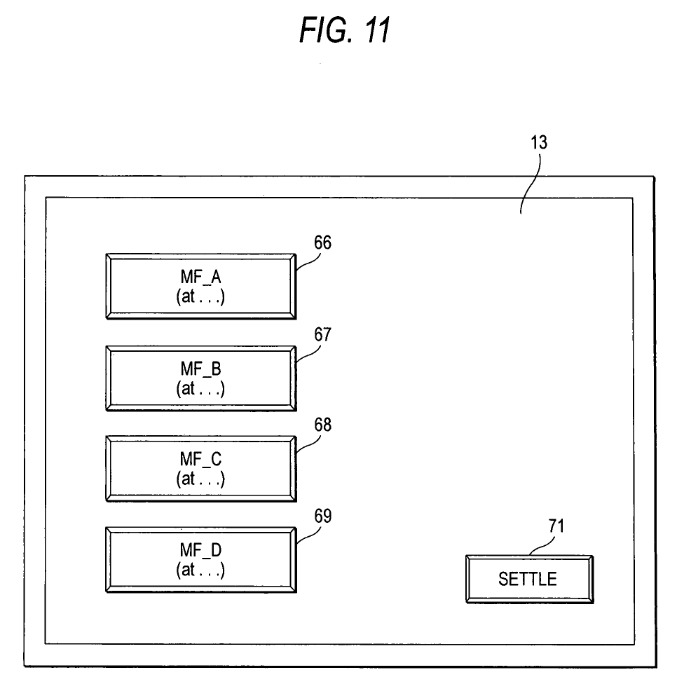

Now, FIG. 11 shows a modification of the display of the operation panel 13. On the display screen of the operation panel 13, based on the composite machine information obtained by the read section 44, there are displayed select buttons 66˜69 describing the apparatus name and installation place of a composite machine which has already set up an application that can be set up in the composite machine 200. And, when the select process section 46 detects that one of the select buttons 66˜69 has been selected by the user, the select process section 46 next, based on the application information obtained by the read section 44, displays the select button (similarly to the select buttons 61˜63 shown in FIG. 10) describing the application name of the application set up in the selected composite machine, thereby prompting the user to select the application.

Now, description will be given here of the settle button 71 displayed on the display screen of the operation panel 13 shown in FIGS. 10 and 11. On detecting that the settle button 71 has been selected by the user, the select process section 46 gains access to the corresponding composite machine and checks whether an application specified by the application information is set up in the corresponding apparatus or not with respect to all pieces of application information recorded on the composite apparatus data area 93 of the memory 86 included in the IC chip 8. And, when the application is not set up or when communication with the composite machine is not possible, the select process section 46 erases the application information about the present application and other pieces of information belong to this application from the composite machine data area 93.

Next, the introduction section 42 sets up the application, which has been obtained by the obtaining section 41, in its own apparatus (S27). Since the operation of the introduction section 42 has been already described above, the detailed description thereof is omitted here.

After then, the recording section 43 outputs the information about the application set up by the introduction section 42 and other pieces of information to the IC card reader 30 to thereby record these pieces of information on the composite machine data area 93 of the memory 86 included in the IC chip 8 owned by the user (S28). The operation of the recording section 43 is the same as described above and, therefore, the detailed description thereof is omitted here.

In the above-mentioned manner, there is ended the set up processing which obtains the application from the composite machine 100.

According to the present exemplary embodiment that has been described above, since the application to be used in the operations of the composite machines 100˜400 respectively connected to the network can be directly transmitted and received between the composite machines 100˜400, there is eliminated the need for a server apparatus or the like to manage the composite machines in a unified manner, thereby being able to simplify the structure of the application sharing system. Especially, when the composite machines 100˜400 are installed in a store such as a convenience store, the number of users to use the composite machines 100˜400 is large and thus it seems difficult to manage them in a unified manner; and, therefore, it is convenient to transmit and receive the application directly between the composite machines 100˜400.

Also, since information to be recorded on the memory 86 included in the IC chip 8 owned by the user is, for example, composite machine information, address information, application information and use function information, when compared with a system in which an application itself is stored in the memory 86, the use capacity of the memory 86 can be reduced and thus more information can be recorded on the memory 86 accordingly.

And, since the judging section 45, based on the use function information (function information) obtained by the read section 44, checks whether its own apparatus has a function of the kind described in this use function information or not, it is possible to obtain properly the application that can be used in its own apparatus.

Also, when two or more composite machines have set up the application, by selecting the composite machine having good transfer efficiency, the application can be obtained quickly.

And, the select process section 46, as shown in FIG. 11, displays the select buttons 66˜69 respectively describing the apparatus names of the composite machines and the installation places of the composite machines on the display screen of the operation panel 13 and, next, displays a select button describing the application name of the application set up in the selected composite machine. This makes it possible for the user to select a desired application according to the apparatus name and apparatus installation place.

Also, when there is selected the settle button 71 shown in FIGS. 10 and 11, the select process section 46 gains access to the composite machine, and when it finds that the application is not set up in the present composite machine or that it is impossible to communicate with the present composite machine, the select process section 46 erases, from the composite machine data area 93, the application information about such application and other information belonging to such application information. This makes it possible to settle the information about the application that cannot be obtained.

Also, when an application is obtained from the composite machine 100 and is set up in its own apparatus, the recording section 43 records the information about the present application and other similar information on the IC chip 8. Thanks to this, when the other composite machines 300 and 400 are used by the user, the application can be obtained from either the composite machine 100 or the composite machine 200.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. An application sharing system comprising:
a first apparatus; and
a second apparatus, connected to each other through a communication channel,
wherein the first apparatus comprises:
an introducing unit that introduces an application used by a function owned by the first apparatus into the first apparatus; and
a recording unit that records not only function information for specifying the function of the first apparatus using the application but also address information of the first apparatus on a portable recording medium, and
the second apparatus comprises:
a reading unit that reads out the function information and the address information from the portable recording medium; and
an obtaining unit that obtains the application from the first apparatus according to the address information when the second apparatus has the function to be specified by the function information.

2. The application sharing system according to claim 1, comprising:
a plurality of apparatuses connected to each other through a communication channel,
wherein when the application is introduced into the plurality of apparatuses and the address information of each of the plurality of apparatuses is recorded on the portable recording medium, the obtaining unit transmits a packet to each of the plurality of apparatuses based on the address information of each of the plurality of apparatuses and decides one of the plurality of apparatuses for obtaining the application based on the packet returned thereto.

3. The application sharing system according to claim 1,
wherein the recording unit further records information about a name and an installation place of the first apparatus on the portable recording medium, and
the reading unit further reads out the information about the name and the installation place of the first apparatus from the portable recording medium.

4. An apparatus comprising:
a reading unit that reads out not only function information for specifying function of another apparatus using an application introduced into the another apparatus but also address information of the another apparatus from a portable recording medium; and
an obtaining unit that obtains the application from the another apparatus through a communication channel based on the address information when the apparatus has the function to be specified by the function information.

5. The apparatus according to claim 4, further comprising:
a recording unit that records not only function information for specifying function of the apparatus using application introduced thereinto but also address information of the apparatus on a portable recording medium.

6. The apparatus according to claim 5,
wherein the reading unit further reads out information about a name and an installation place of the another apparatus from the portable recording medium, and
the recording unit further records information about a name and an installation place of the apparatus on the portable recording medium.

7. A computer readable medium storing a program for causing a computer owned by an apparatus to execute a process for sharing an application, the process comprising:
reading out not only function information for specifying function of another apparatus using an application introduced into the another apparatus but also address information of the another apparatus from a portable recording medium; and
obtaining the application from the another apparatus through a communication channel based on the address information when the apparatus has the function to be specified by the function information.

8. A computer data signal embodied in a carrier wave for enabling a computer to perform a process for sharing an application, the process comprising:
reading out not only function information for specifying function of another apparatus using an application introduced into the another apparatus but also address information of the another apparatus from a portable recording medium; and
obtaining the application from the another apparatus through a communication channel based on the address information when the apparatus has the function to be specified by the function information.
